(19) United States
(12) Patent Application Publication
(10) Pub. No.: US 2024/0185553 A1
(43) Pub. Date: Jun. 6, 2024

(54) IMAGE PROCESSING METHOD AND INFORMATION PROCESSING DEVICE

(71) Applicant: Fujitsu Limited, Kawasaki-shi (JP)

(72) Inventor: Meguru YAMAZAKI, Kawasaki (JP)

(73) Assignee: Fujitsu Limited, Kawasaki-shi (JP)

(21) Appl. No.: 18/466,127

(22) Filed: Sep. 13, 2023

(30) Foreign Application Priority Data
Dec. 2, 2022 (JP) 2022-193284

(51) Int. Cl. G06V 10/26; G06T 7/12; G06T 7/187; G06T 7/60

(52) U.S. Cl. CPC G06V 10/267; G06T 7/12; G06T 7/187; G06T 7/60; G06T 2207/20021; G06T 2207/30236; G06V 20/54; G06V 2201/08

(57) ABSTRACT

A non-transitory computer-readable recording medium stores a program for causing a computer to execute a process, the process includes determining a size of an overlapping area such that adjacent divided areas among a plurality of divided areas obtained by dividing a captured image have the overlapping area with each other across a boundary between the adjacent divided areas, determining a plurality of partial areas that respectively correspond to the plurality of divided areas based on the determined size of the overlapping area, and cutting out a plurality of partial images that respectively correspond to the plurality of partial areas from the captured image.

### CROSS-REFERENCE TO RELATED APPLICATION

This application is based upon and claims the benefit of priority of the prior Japanese Patent Application No. 2022-193284, filed on Dec. 2, 2022, the entire contents of which are incorporated herein by reference.

### FIELD

The embodiments discussed herein are related to an image processing method and an information processing device.

### BACKGROUND

In recent years, a technology of capturing an image of an area to be monitored by using a camera and performing image processing on the captured image to detect a desired object has become widespread. Furthermore, as such an object detection technology, a technology using a machine learning method has also become widespread.

Since the number of pixels of a camera used for monitoring tends to increase, the number of pixels may greatly exceed the number of pixels that may be handled in object detection processing. In this case, in some cases, for example, when a captured image is reduced to the number of pixels that may be handled in the object detection processing, a size of an object appeared in the original captured image is reduced in the reduced image, and the object is not detected from the reduced image. For such a problem, a technology of dividing a captured image into a plurality of divided images and performing object detection from each of the divided images has been proposed.

Japanese Laid-open Patent Publication No. 2022-101321 and Japanese Laid-open Patent Publication No. 2013-41481 are disclosed as related art.

### SUMMARY

According to an aspect of the embodiments, a non-transitory computer-readable recording medium stores a program for causing a computer to execute a process, the process includes determining a size of an overlapping area such that adjacent divided areas among a plurality of divided areas obtained by dividing a captured image have the overlapping area with each other across a boundary between the adjacent divided areas, determining a plurality of partial areas that respectively correspond to the plurality of divided areas based on the determined size of the overlapping area, and cutting out a plurality of partial images that respectively correspond to the plurality of partial areas from the captured image.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example and a processing example of an image processing device according to a first embodiment;

FIG. 2 is a diagram illustrating a configuration example of a vehicle detection system according to a second embodiment;

FIG. 3 is a diagram illustrating a hardware configuration example of a vehicle detection device;

FIG. 4 is a diagram illustrating an outline of vehicle detection processing in the vehicle detection device;

FIG. 5 is a diagram illustrating a first comparative example of the vehicle detection processing;

FIG. 6 is a diagram illustrating a second comparative example of the vehicle detection processing;

FIG. 7 is a diagram illustrating a problem in the second comparative example;

FIG. 8 is a diagram illustrating the vehicle detection processing in the second embodiment;

FIG. 9 is a diagram illustrating partial image generation processing;

FIGS. 10A and 10B are diagrams for describing a size of an overlapping area;

FIG. 11 is a diagram illustrating a configuration example of processing functions included in the vehicle detection device;

FIG. 12 is a diagram illustrating an internal configuration example of a partial image generation unit;

FIG. 13 is an example of a flowchart illustrating a procedure of the entire vehicle detection processing;

FIG. 14 is an example of a flowchart illustrating a procedure of overlap width determination processing; and

FIG. 15 is a diagram illustrating an example of generation of partial images based on divided areas divided into nine.

### DESCRIPTION OF EMBODIMENTS

In a case where the captured image is divided and the object detection is performed as described above, there is a problem that it is difficult to detect an object positioned across a boundary between the divided images.

Hereinafter, embodiments will be described with reference to the drawings.

### First Embodiment

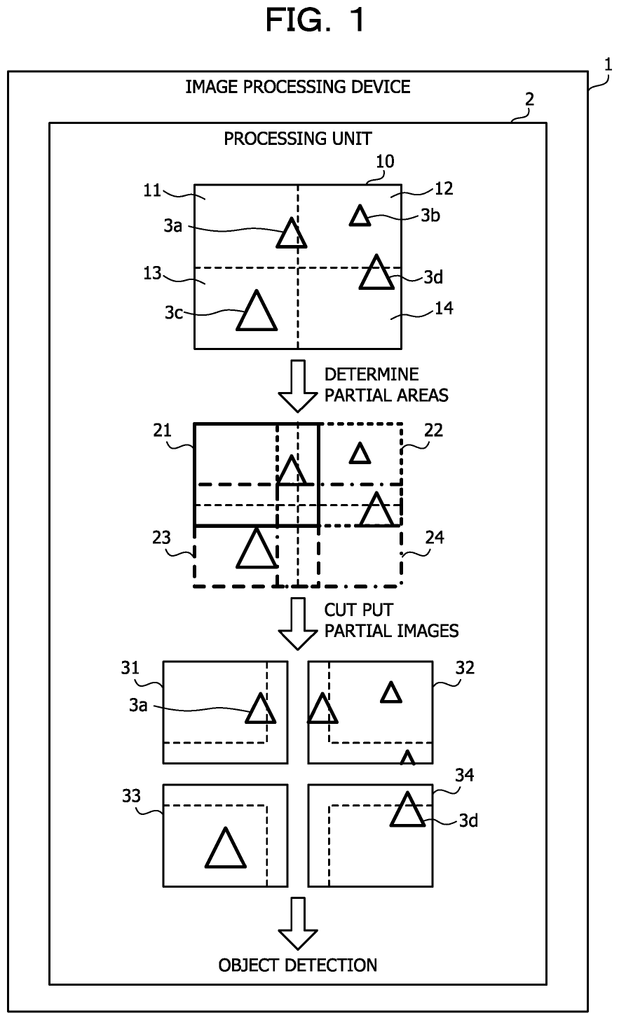

FIG. 1 is a diagram illustrating a configuration example and a processing example of an image processing device according to a first embodiment. An image processing device 1 illustrated in FIG. 1 includes a processing unit 2. The processing unit 2 is, for example, a processor.

The image processing device 1 generates, based on an input captured image 10, an image that may improve object detection accuracy from the captured image 10. As an example, the captured image 10 illustrated in FIG. 1 includes four instances 3a to 3d of a predetermined object to be detected.

Here, for example, it is assumed that the number of pixels of the input captured image 10 is greater than the number of pixels of an image to be processed, which is defined in object detection processing. In this case, for example, a method is conceivable in which the number of pixels of the captured image 10 is reduced to be the defined number of pixels of the object detection processing, and object detection is performed from the reduced captured image 10. However, in this method, a size of an object that appears in the original captured image 10 becomes small in the reduced image, and the object may not be detected from the reduced image.

Thus, as an example of another method, a method is conceivable in which the captured image 10 is divided into a plurality of divided images and object detection is performed from each of the divided images. However, in this method, it is difficult to detect an object positioned across a boundary between the divided images. In the captured image 10 illustrated in FIG. 1, boundaries among divided areas 11 to 14 in a case where the captured image 10 is divided into four are indicated by broken lines. In this example, the objects 3a and 3d are positioned across the boundaries. In this case, there is a high possibility that the objects 3a and 3d may not be detected even when object detection is performed from each image of the divided areas 11 to 14 obtained by the division into four.

Thus, the processing unit 2 generates, based on the captured image 10, a plurality of partial images that enables detection of the objects 3a and 3d positioned over the boundary lines as well by the following processing. Note that, in the following description, the partial images are generated based on the divided areas 11 to 14 obtained by dividing the captured image 10 into four, but the number of times of division of the divided areas serving as the basis is not limited, and the captured image 10 may be divided into, for example, nine or 16.

The processing unit 2 determines sizes of overlapping areas such that the overlapping areas with each other are generated between the adjacent divided areas across the boundaries among the divided areas 11 to 14 obtained by dividing the captured image 10 into four. Based on the determined sizes of the overlapping areas, the processing unit 2 determines partial areas 21 to 24 respectively corresponding to the divided areas 11 to 14.

In the example in FIG. 1, the partial area 21 is determined by enlarging the divided area 11 in a right direction and a downward direction. Furthermore, the partial area 22 is determined by enlarging the divided area 12 in a left direction and the downward direction. Moreover, the partial area 23 is determined by enlarging the divided area 13 in the right direction and an upward direction. Furthermore, the partial area 24 is determined by enlarging the divided area 14 in the left direction and the upward direction.

As a result, the overlapping areas are generated between the laterally adjacent partial areas 21 and 22 and partial areas 23 and 24. Among these, the former overlapping area includes the entire object 3a. Furthermore, the overlapping areas are generated between the longitudinally adjacent partial areas 21 and 23 and partial areas 22 and 24. Among these, the latter overlapping area includes the entire object 3d.

Next, the processing unit 2 cuts out partial images 31 to 34 respectively corresponding to the determined partial areas 21 to 24 from the captured image 10. The cut-out partial images 31 to 34 are images to be subjected to object detection.

As illustrated in FIG. 1, the entire object 3a positioned at the boundary between the divided areas 11 and 12 is included in the partial image 31. Thus, by performing object detection from the partial image 31, a possibility that the object 3a is detected increases. Furthermore, the entire object 3d positioned at the boundary between the divided areas 12 and 14 is included in the partial image 34. Thus, by performing object detection from the partial image 34, a possibility that the object 3d is detected increases.

In this way, according to the image processing device 1, it is possible to generate, based on the input captured image 10, an image that may improve object detection accuracy.

### Second Embodiment

Next, as an example of the object detection processing, processing of detecting a vehicle traveling in a road will be described.

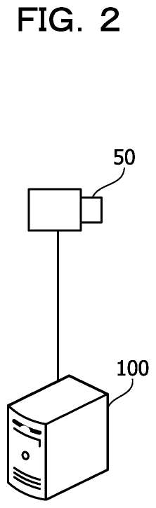

FIG. 2 is a diagram illustrating a configuration example of a vehicle detection system according to a second embodiment. The vehicle detection system illustrated in FIG. 2 includes a camera 50 and a vehicle detection device 100. Note that the vehicle detection device 100 is an example of the image processing device 1 illustrated in FIG. 1.

The camera 50 is a monitoring camera that monitors a road in which a vehicle travels. The camera 50 captures an image of the road and transmits the captured image to the vehicle detection device 100. The vehicle detection device 100 is coupled to the camera 50 via a network, for example. The vehicle detection device 100 receives the captured image from the camera 50, and detects the vehicle from the received captured image. A detection result of the vehicle is used for purposes such as, for example, observation of a road traffic volume and a road use situation, and formulation of a road maintenance plan.

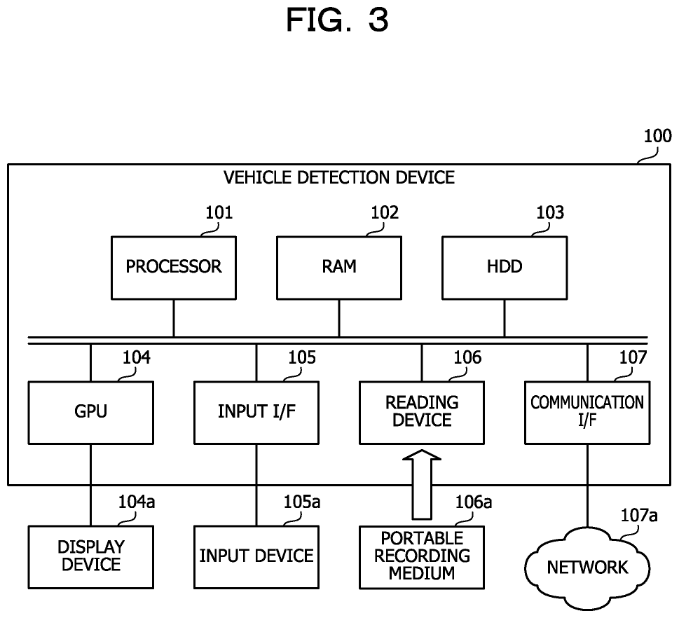

FIG. 3 is a diagram illustrating a hardware configuration example of the vehicle detection device 100. The vehicle detection device 100 is implemented as, for example, a computer (information processing device) as illustrated in FIG. 3. The vehicle detection device 100 illustrated in FIG. 3 includes a processor 101, a random access memory (RAM) 102, a hard disk drive (HDD) 103, a graphics processing unit (GPU) 104, an input interface (I/F) 105, a reading device 106, and a communication interface (I/F) 107.

The processor 101 integrally controls the entire vehicle detection device 100. The processor 101 is, for example, a central processing unit (CPU), a micro processing unit (MPU), a digital signal processor (DSP), an application specific integrated circuit (ASIC), or a programmable logic device (PLD). Furthermore, the processor 101 may be a combination of two or more elements of a CPU, an MPU, a DSP, an ASIC, and a PLD. Note that the processor 101 is an example of the processing unit 2 illustrated in FIG. 1.

The RAM 102 is used as a main storage device of the vehicle detection device 100. The RAM 102 temporarily stores at least a part of an operating system (OS) program or an application program to be executed by the processor 101. Furthermore, the RAM 102 stores various types of data needed for processing by the processor 101.

The HDD 103 is used as an auxiliary storage device of the vehicle detection device 100. The HDD 103 stores the OS program, the application program, and various types of data. Note that another type of nonvolatile storage device, such as a solid state drive (SSD), may also be used as the auxiliary storage device.

A display device 104a is coupled to the GPU 104. The GPU 104 causes the display device 104a to display an image according to an instruction from the processor 101. As the display device, a liquid crystal display, an organic electroluminescence (EL) display, or the like may be used.

An input device 105a is coupled to the input interface 105. The input interface 105 transmits a signal output from the input device 105a to the processor 101. As the input device 105a, a keyboard, a pointing device, or the like may be used. As the pointing device, a mouse, a touch panel, a tablet, a touch pad, a track ball, or the like may be used.

A portable recording medium 106a is attached to and detached from the reading device 106. The reading device 106 reads data recorded in the portable recording medium 106a and transmits the read data to the processor 101. As the portable recording medium 106a, an optical disk, a semiconductor memory, or the like may be used.

The communication interface 107 exchanges data with another device via a network 107a. For example, in a case where the camera 50 is coupled to the vehicle detection device 100 via the network 107a, the communication interface 107 receives data of a captured image transmitted from the camera 50.

The processing functions of the vehicle detection device 100 may be implemented with the hardware configuration as described above.

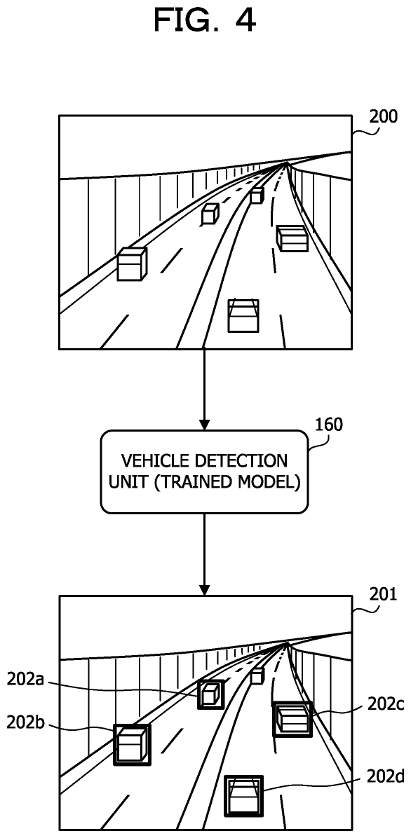

FIG. 4 is a diagram illustrating an outline of vehicle detection processing in the vehicle detection device. The vehicle detection device 100 includes a vehicle detection unit 160 that detects a position of a vehicle from an input image. In the present embodiment, as an example, the vehicle detection unit 160 is implemented as a trained model by machine learning. Furthermore, the vehicle detection unit 160 detects a rectangular bounding box including an area where a vehicle is present from the input image, and outputs an image in which the detected bounding box is superimposed on the input image. For example, in the output image from the vehicle detection unit 160, a position of the vehicle detected from the input image is detected as a position of the bounding box.

FIG. 4 illustrates, as an example, a case where a captured image 200 captured by the camera 50 is input to the vehicle detection unit 160. In this case, the vehicle detection unit 160 outputs an output image 201 in which bounding boxes indicating positions of vehicles detected from the captured image 200 are displayed. In the example in FIG. 4, four vehicles are detected from the captured image 200, and bounding boxes 202a to 202d corresponding to the respective vehicles are displayed in the output image 201.

The trained model that enables such vehicle detection is generated by, for example, machine learning (for example, deep learning) using a large number of images in which vehicles appear as pieces of teacher data. To these pieces of teacher data, pieces of position information regarding bounding boxes corresponding to positions of the vehicles are added, and these pieces of position information are used as correct answer data during the machine learning.

Note that the vehicle detection unit 160 may be capable of not only detecting a position of a vehicle but also identifying a type of the detected vehicle. In this case, at the time of the training, in addition to the position information regarding the bounding boxes, labels indicating types of the vehicles are used as the correct answer data.

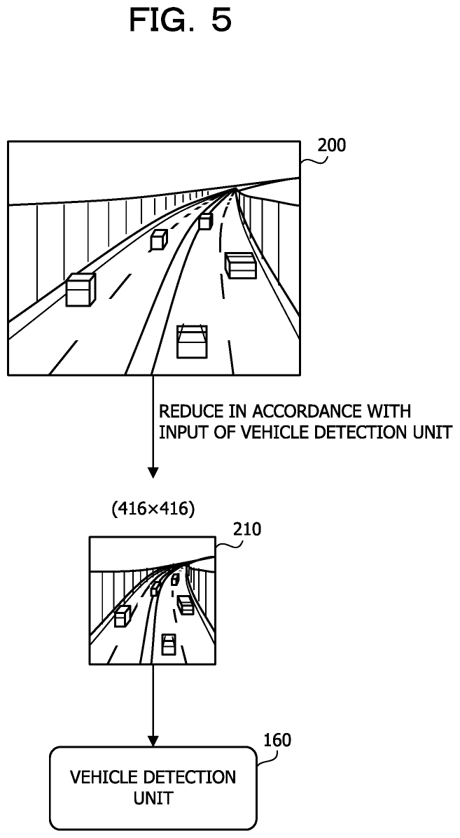

Next, comparative examples of the vehicle detection processing using the vehicle detection unit 160 as described above will be described with reference to FIGS. 5 to 7.

FIG. 5 is a diagram illustrating a first comparative example of the vehicle detection processing.

With improvement in performance of the camera 50 and an image compression technology, increase in a network speed, and the like, an image size (the number of pixels and resolution) of a captured image input to the vehicle detection device 100 is increased. For example, a so-called “4K image” in which the number of pixels in a horizontal direction is about 4000 pixels may be transmitted from the camera 50 to the vehicle detection device 100.

On the other hand, for the trained model for object detection such as the vehicle detection unit 160, the larger the image size of the input image, the larger a processing load of the object detection and the longer a processing time. Furthermore, the image size of the input image to the vehicle detection unit 160 matches the image size of the teacher image used at the time of the training. Thus, the larger the image size of the input image, the larger the image size of the teacher image, and as a result, the processing load at the time of the training also increases, and the processing time becomes longer. For such a reason, commonly, the image size that may be input to the trained model for the object detection is often suppressed to about a certain level or less.

In such a case, even when the image size of the captured image 200 increases, the captured image 200 is reduced in accordance with an input size defined by the trained model, and the reduced image is input to the trained model. In the example in FIG. 5, it is assumed that the input size to the vehicle detection unit 160 is defined as 416×416 pixels. In this case, the captured image 200 from the camera 50 is reduced to a reduced image 210 of 416×416 pixels, and the reduced image 210 is input to the vehicle detection unit 160.

Here, the vehicle detection unit 160 may detect a vehicle that appears in a size equal to or greater than a certain detectable size in the input image, but may not detect a vehicle that appears in a size smaller than the certain detectable size. In a case where the captured image 200 is reduced and input to the vehicle detection unit 160 as described above, even in a case where a certain vehicle appears in a size equal to or greater than the detectable size in the original captured image 200, the size of the vehicle may be smaller than the detectable size in the reduced image 210. In this case, the vehicle detection unit 160 may not detect the vehicle.

As the image size of the captured image 200 from the camera 50 is greater, even a vehicle that appears in a relatively small size in the captured image 200 appears with high image quality (great number of pixels). Therefore, originally, it is expected that such a vehicle that appears in a small size may also be detected by the vehicle detection unit 160. However, there is a problem that expected vehicle detection performance may not be obtained when the captured image 200 is reduced at the time of vehicle detection.

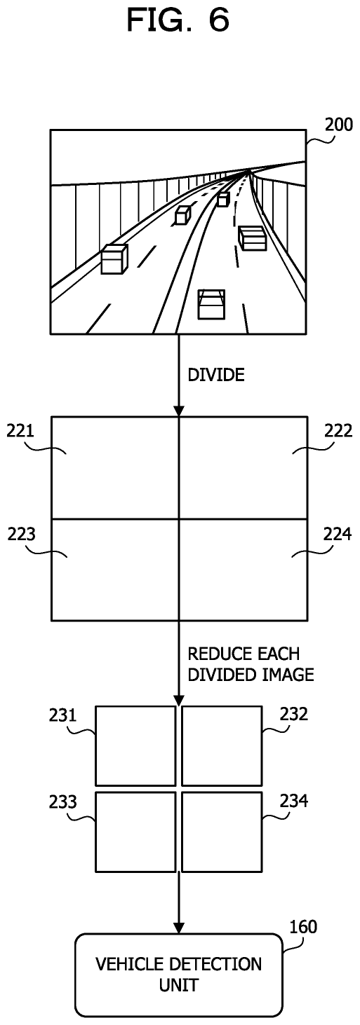

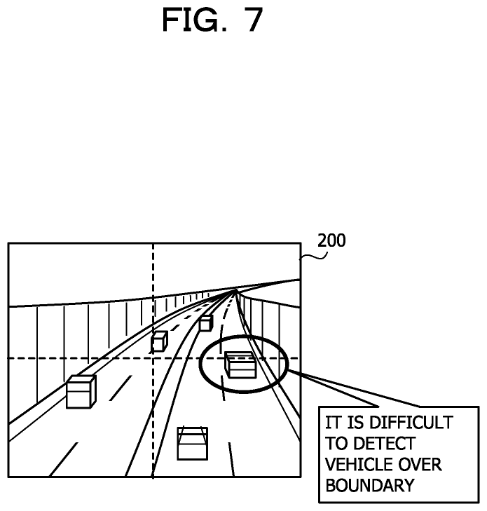

FIG. 6 is a diagram illustrating a second comparative example of the vehicle detection processing. Furthermore, FIG. 7 is a diagram illustrating a problem in the second comparative example.

In order to enable the vehicle detection unit 160 to detect a vehicle that appears in a small size in the original captured image 200, it is needed to increase the number of pixels of an image input to the vehicle detection unit 160 by increasing an enlargement/reduction ratio when the captured image 200 is reduced as much as possible (so as to approach 100%). As such a method, a method is conceivable in which the original captured image 200 is divided, images obtained by the division are reduced, and the reduced images are input to the vehicle detection unit 160.

In the example in FIG. 6, the captured image 200 is divided into four divided images 221 to 224 of the same size. Then, the divided images 221 to 224 are respectively reduced to reduced images 231 to 234 having the input size to the vehicle detection unit 160, and the reduced images 231 to 234 are input to the vehicle detection unit 160.

In this case, the vehicle detection unit 160 detects a vehicle from each of reduced images 231 to 234. When it is assumed that one or more vehicles having a size equal to or greater than the detectable size appear in each of the reduced images 231 to 234, the vehicle detection unit 160 outputs information regarding a bounding box to each of the reduced images 231 to 234. The information regarding each bounding box is enlarged in accordance with the enlargement/reduction ratio between the divided images 221 to 224 and the reduced images 231 to 234, and the enlarged bounding box is superimposed on the input image to generate a final output image.

According to such a method, the number of pixels of each image input to the vehicle detection unit 160 becomes larger compared with the method illustrated in FIG. 5. Thus, the vehicle detection unit 160 may easily detect a vehicle that appears in a small size in the original captured image 200. For example, a lower limit value of the size of the vehicle that may be detected by the vehicle detection unit 160 among the vehicles that appear in the original captured image 200 decreases. Therefore, vehicle detection accuracy is improved.

However, this method has the following problem. As illustrated in FIG. 7, a vehicle positioned over a boundary between divided images obtained by dividing the captured image 200 is divided across the boundary. Therefore, there is a problem that it is difficult to detect such a vehicle positioned over the boundary.

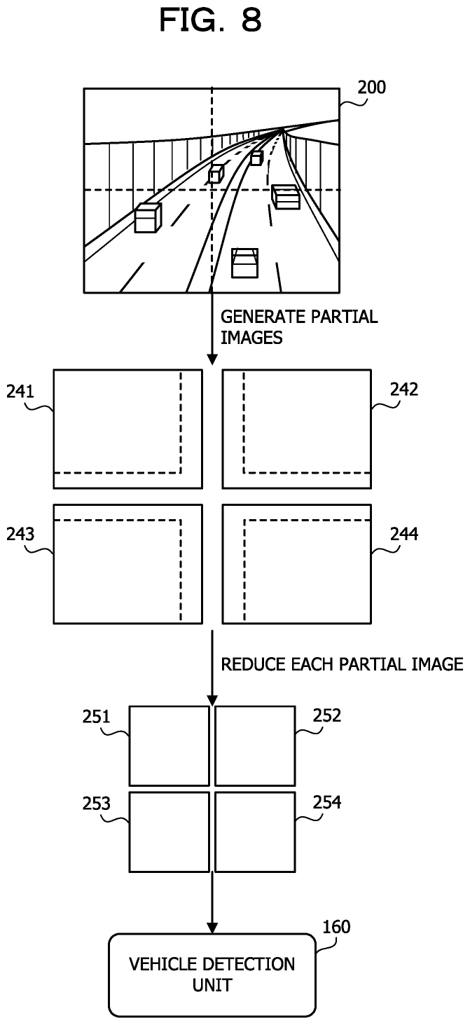

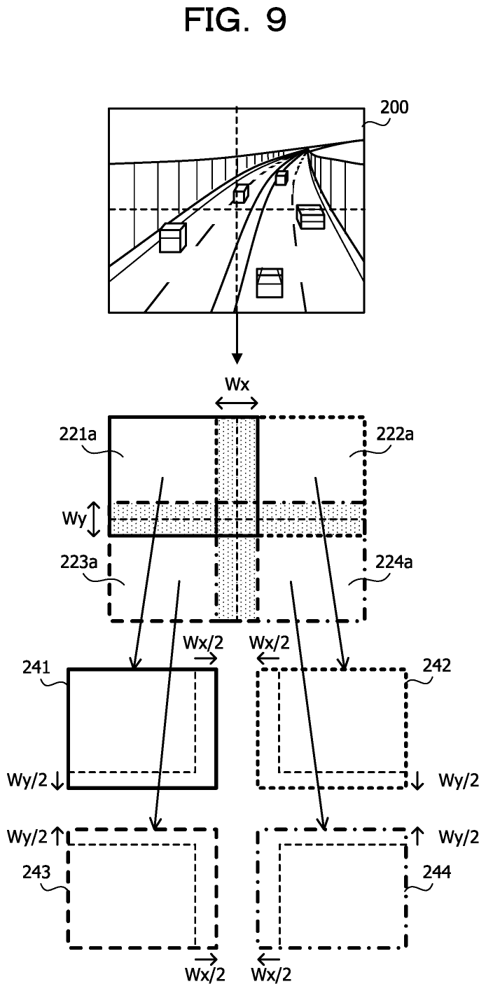

FIG. 8 is a diagram illustrating the vehicle detection processing in the second embodiment. Furthermore, FIG. 9 is a diagram illustrating partial image generation processing.

As illustrated in FIG. 8, the vehicle detection device 100 of the present embodiment generates, based on the respective divided areas obtained by dividing the captured image 200, partial images 241 to 244 corresponding to the respective divided areas. The partial images 241 to 244 are images having overlapping areas with the other partial images, and are generated by a procedure illustrated in FIG. 9.

As illustrated in FIG. 9, the vehicle detection device 100 enlarges divided areas 221a to 224a obtained by dividing the captured image 200 into four, such that overlapping areas with each other are generated between the adjacent divided areas across boundaries among the divided areas 221a to 224a. In FIG. 9, the overlapping areas are indicated by hatching. The vehicle detection device 100 generates the partial images 241 to 244 by cutting out the respective enlarged areas from the captured image 200.

For example, an overlapping area with an overlap width Wx is generated between the laterally adjacent partial areas, and an overlapping area with an overlap width Wy is generated between the longitudinally adjacent partial areas. In this case, the partial image 241 is generated by cutting out an area obtained by enlarging the divided area 221a in the right direction by Wx/2 and in the downward direction by Wy/2 from the captured image 200. Furthermore, the partial image 242 is generated by cutting out an area obtained by enlarging the divided area 222a in the left direction by Wx/2 and in the downward direction by Wy/2 from the captured image 200. Moreover, the partial image 243 is generated by cutting out an area obtained by enlarging the divided area 223a in the right direction by Wx/2 and in the upward direction by Wy/2 from the captured image 200. Furthermore, the partial image 244 is generated by cutting out an area obtained by enlarging the divided area 224a in the left direction by Wx/2 and in the upward direction by Wy/2 from the captured image 200.

As illustrated in FIG. 8, the vehicle detection device 100 reduces the partial images 241 to 244 generated in this way to reduced images 251 to 254 having the input size to the vehicle detection unit 160, respectively, and inputs the reduced images 251 to 254 to the vehicle detection unit 160. The vehicle detection unit 160 detects a vehicle from each of reduced images 251 to 254.

According to the processing described above, when a vehicle appears in the captured image 200 in a size equal to or smaller than the overlap width, the entire vehicle is included in any one of the partial images even in a case where the vehicle is positioned at the boundary of the divided areas. Thus, the vehicle detection unit 160 may detect this vehicle from any one of the partial images. Therefore, it becomes possible to improve the vehicle detection accuracy.

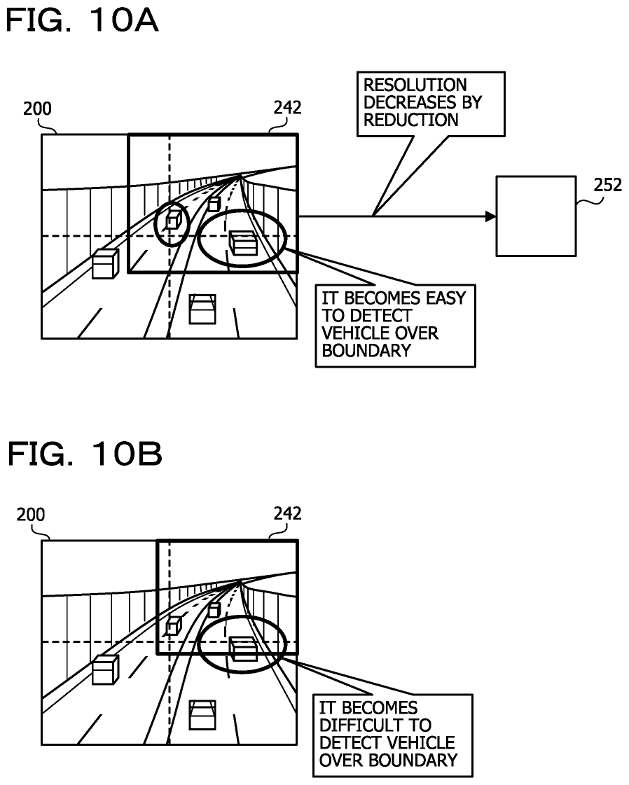

FIGS. 10A and 10B are diagrams for describing a size of an overlapping area. FIG. 10A illustrates a case where the overlapping area is large, and FIG. 10B illustrates a case where the overlapping area is small.

FIGS. 10A and 10B exemplify a case where the partial image 242 is cut out from the captured image 200. As illustrated in FIG. 10A, the larger the overlapping area with the adjacent other partial images in the area of the partial image 242, the easier the vehicle detection unit 160 detects a vehicle positioned over the boundary between the divided areas. On the other hand, since an image size of the partial image 242 itself increases as the overlapping area increases, resolution greatly decreases when the partial image 242 is reduced to generate the reduced image 252. Thus, it becomes difficult for the vehicle detection unit 160 to detect a vehicle that appears in a small size in the captured image 200.

Furthermore, as illustrated in FIG. 10B, the smaller the overlapping area with the adjacent other partial images in the area of the partial image 242, the smaller the image size of the partial image 242 itself, and thus, the resolution is less likely to decrease when the partial image 242 is reduced to generate the reduced image 252. Thus, it becomes easy for the vehicle detection unit 160 to detect a vehicle that appears in a small size in the captured image 200. On the other hand, the smaller the overlapping area, the more difficult it becomes to detect a vehicle positioned over the boundary between the divided areas.

In this way, there is a problem when the overlapping area is too large or too small, and it is not easy to determine an appropriate size of the overlapping area. Thus, the vehicle detection device 100 of the present embodiment determines the size of the overlapping area when the partial images are generated by performing statistical calculation based on sizes of bounding boxes for objects detected from captured images in the past. By this statistical calculation, the vehicle detection device 100 may calculate, for example, a size of the minimum overlapping area including many of the bounding boxes detected in the past. As a result, the vehicle detection device 100 may minimize the sizes of the partial images while improving the detection accuracy of a vehicle over the boundary of the divided areas, and may also easily detect a vehicle that appears in a small size in the captured image 200.

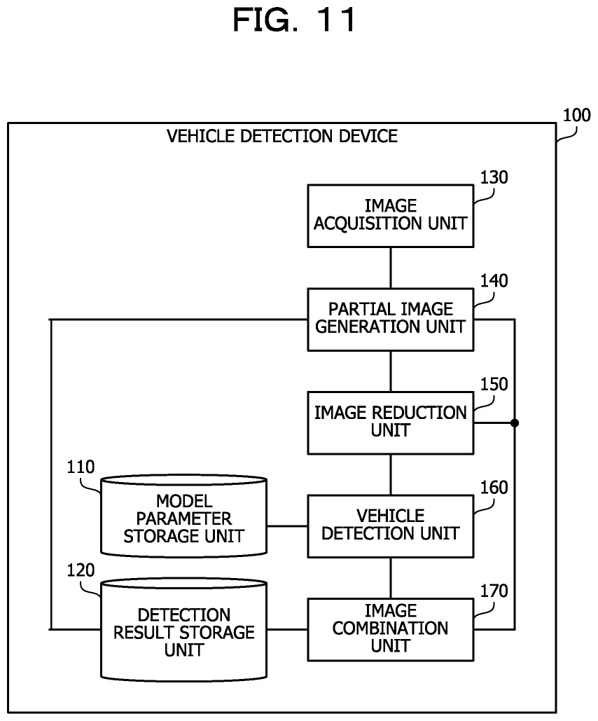

FIG. 11 is a diagram illustrating a configuration example of the processing functions included in the vehicle detection device. As illustrated in FIG. 11, the vehicle detection device 100 includes a model parameter storage unit 110, a detection result storage unit 120, an image acquisition unit 130, a partial image generation unit 140, an image reduction unit 150, the vehicle detection unit 160, and an image combination unit 170.

The model parameter storage unit 110 and the detection result storage unit 120 are storage areas of the storage devices included in the vehicle detection device 100, such as the RAM 102 and the HDD 103.

The model parameter storage unit 110 stores model parameters indicating the trained model corresponding to the vehicle detection unit 160. For example, in a case where the trained model is formed as a neural network, a weight coefficient between nodes over the neural network is included in the model parameters.

In the detection result storage unit 120, information indicating detection results of vehicles by the vehicle detection unit 160 is accumulated. For example, in the detection result storage unit 120, sizes (lateral lengths and longitudinal lengths) of bounding boxes indicating positions of the detected vehicles are accumulated. Note that the size of the bounding box is an example of a size of a detection area where the vehicle is detected.

Processing of the image acquisition unit 130, the partial image generation unit 140, the image reduction unit 150, the vehicle detection unit 160, and the image combination unit 170 are implemented by, for example, the processor 101 executing a predetermined application program.

The image acquisition unit 130 acquires data of a captured image transmitted from the camera 50.

The partial image generation unit 140 generates a plurality of partial images based on the captured image. At this time, the partial image generation unit 140 determines the overlap widths Wx and Wy of overlapping areas between adjacent partial images based on the sizes of the bounding boxes accumulated in the detection result storage unit 120.

The image reduction unit 150 reduces each of the generated partial images to a reduced image having an input size defined by the vehicle detection unit 160. A reduction ratio in this reduction processing is determined based on a size of the overlapping area among the partial images.

The vehicle detection unit 160 inputs each reduced image from the image reduction unit 150 to the trained model based on the model parameters stored in the model parameter storage unit 110. With this configuration, the vehicle detection unit 160 detects a vehicle from each reduced image. In a case where a vehicle is detected from the reduced image, information regarding the bounding box indicating the vehicle detection area in the reduced image is output.

The image combination unit 170 enlarges the bounding box in accordance with a size of an original divided image based on the information regarding the bounding box output from the vehicle detection unit 160, and superimposes the enlarged bounding box on the original divided image. The image combination unit 170 combines the respective divided images on which the bounding boxes are superimposed, and outputs an image obtained by the combination. Furthermore, the image combination unit 170 stores the size (a lateral width and a longitudinal width) of the enlarged bounding box in the detection result storage unit 120.

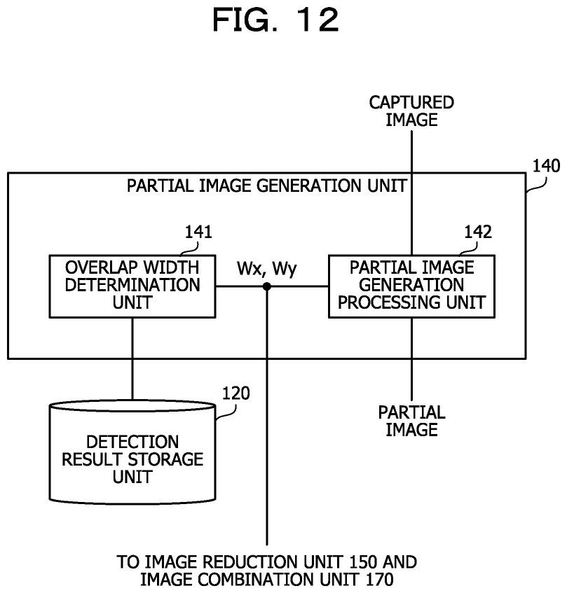

FIG. 12 is a diagram illustrating an internal configuration example of the partial image generation unit. As illustrated in FIG. 12, the partial image generation unit 140 includes an overlap width determination unit 141 and a partial image generation processing unit 142.

The overlap width determination unit 141 acquires sizes of bounding boxes detected in the past from the detection result storage unit 120, and performs statistical calculation based on the acquired sizes to determine the overlap widths Wx and Wy of the overlapping areas. The partial image generation processing unit 142 determines a size of each partial image based on the overlap widths Wx and Wy determined by the overlap width determination unit 141, and generates a partial image having the determined size.

Here, the overlap width determination unit 141 determines the overlap widths Wx and Wy as follows. For example, the overlap width determination unit 141 calculates an average value Mx of lateral widths and an average value My of longitudinal widths of the bounding boxes acquired from the detection result storage unit 120. The overlap width determination unit 141 determines the overlap width Wx as the average value Mx and determines the overlap width Wy as the average value My. Alternatively, the overlap width determination unit 141 determines a value obtained by adding a predetermined value to the average value Mx as the overlap width Wx, and determines a value obtained by adding a predetermined value to the average value My as the overlap width Wy.

In this way, by determining the overlap widths to be values equal to or greater than the average values of the widths of the bounding boxes, the sizes of the respective partial images are determined such that the sizes of about 50% or more of the vehicles detected in the past are equal to or smaller than the overlap widths.

Furthermore, the following method may be adopted such that the sizes of more vehicles detected in the past become equal to or smaller than the overlap widths. The overlap width determination unit 141 calculates the average value Mx and a standard deviation SDx for the lateral widths of the bounding boxes acquired from the detection result storage unit 120. Furthermore, the overlap width determination unit 141 calculates the average value My and a standard deviation SDy for the longitudinal widths of the bounding boxes acquired from the detection result storage unit 120. The overlap width determination unit 141 determines the overlap widths Wx and Wy according to the following Expressions (1) and (2) based on these calculated values.

Wx=Mx+SDx (1)

Wy=My+SDy (2)

In a case where Expressions (1) and (2) are used, the sizes of the respective partial images are determined such that about 90% of the vehicles detected in the past are equal to or smaller than the overlap widths. With this configuration, even in a case where vehicles of most of the sizes detected in the past present over boundaries between divided areas, the vehicle detection unit 160 may detect these vehicles.

Next, processing of the vehicle detection device 100 will be described with reference to flowcharts.

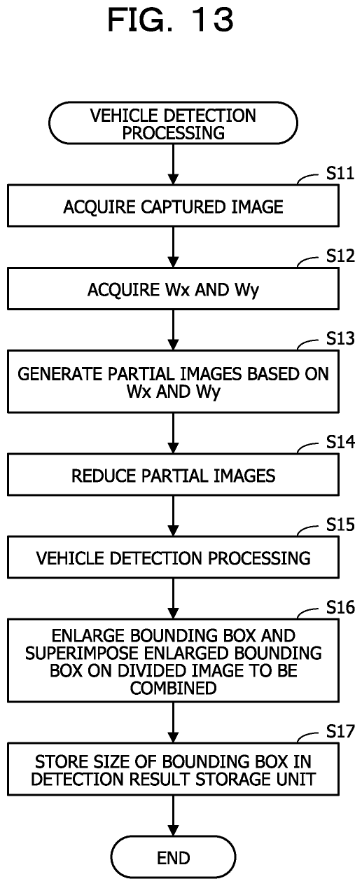

FIG. 13 is an example of a flowchart illustrating a procedure of the entire vehicle detection processing.

[Step S11] The image acquisition unit 130 acquires data of a captured image captured by the camera 50 and transmitted from the camera 50.

[Step S12] In the partial image generation unit 140, the partial image generation processing unit 142 acquires the overlap widths Wx and Wy determined most recently from the overlap width determination unit 141.

[Step S13] The partial image generation processing unit 142 generates a predetermined number of partial images based on the acquired overlap widths Wx and Wy. For example, the partial image generation processing unit 142 determines a size of each partial image based on the acquired overlap widths Wx and Wy, and cuts out each partial image from the captured image with the determined size.

[Step S14] The image reduction unit 150 reduces each generated partial image to a reduced image having an input size defined by the vehicle detection unit 160. In this reduction processing, a lateral reduction ratio is determined according to the overlap width Wx acquired in Step S12, and a longitudinal reduction ratio is determined according to the overlap width Wy acquired in Step S12.

[Step S15] The vehicle detection unit 160 inputs each generated reduced image to the trained model based on the model parameters stored in the model parameter storage unit 110. With this configuration, the vehicle detection unit 160 detects a vehicle from each reduced image. In a case where a vehicle is detected from the reduced image, the vehicle detection unit 160 outputs information regarding a bounding box indicating a vehicle detection area in the reduced image.

[Step S16] The image combination unit 170 enlarges the bounding box in accordance with a size of an original divided image based on the information regarding the bounding box output from the vehicle detection unit 160, and superimposes the enlarged bounding box on the original divided image. The image combination unit 170 combines the respective divided images on which the bounding boxes are superimposed, and outputs an image obtained by the combination.

[Step S17] The image combination unit 170 stores the size (a lateral width and a longitudinal width) of the bounding box enlarged in Step S16 in the detection result storage unit 120.

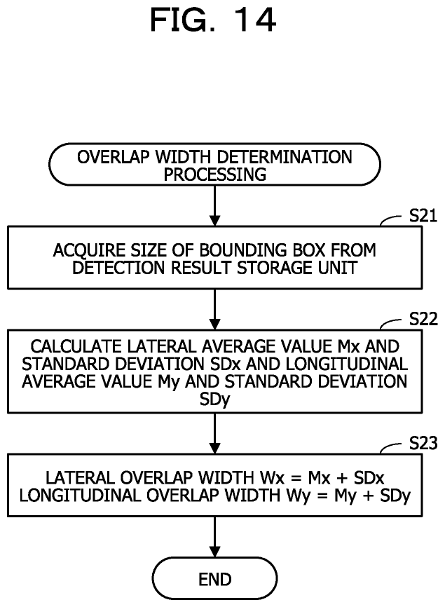

FIG. 14 is an example of a flowchart illustrating a procedure of overlap width determination processing. The processing in FIG. 14 is executed, for example, at regular time intervals. Alternatively, the processing in FIG. 14 may be executed in accordance with the execution in Step S12 in FIG. 13. In this case, for example, the overlap widths Wx and Wy determined by the processing in FIG. 14 are acquired in Step S12.

[Step S21] The overlap width determination unit 141 of the partial image generation unit 140 acquires the size (the lateral width and the longitudinal width) of the bounding box from the detection result storage unit 120. In this processing, for example, the sizes of all the bounding boxes stored in the detection result storage unit 120 are acquired. Alternatively, only a size of a bounding box stored in the detection result storage unit 120 within the most recent certain period may be acquired.

In the following Steps S22 and S23, a processing procedure in a case where the average value and the standard deviation of the sizes of the bounding boxes are used will be described as an example.

[Step S22] The overlap width determination unit 141 calculates the average value Mx and the standard deviation SDx for the acquired lateral widths of the bounding boxes. Furthermore, the overlap width determination unit 141 calculates the average value My and the standard deviation SDy for the acquired longitudinal widths of the bounding boxes.

[Step S23] The overlap width determination unit 141 determines the lateral overlap width Wx according to Expression (1) described above. Furthermore, the overlap width determination unit 141 determines the longitudinal overlap width Wy according to Expression (2) described above.

Note that, in a case where sufficient information is not stored in the detection result storage unit 120 (for example, in a case where the number of pieces of data of the sizes of the bounding boxes is equal to or less than a predetermined number), for example, in Step S23, the overlap widths Wx and Wy may be determined to predetermined fixed values. This fixed value may be, for example, a value calculated based on a detection result of a vehicle at another place where an image capturing condition (such as a positional relationship with a road) is close to that of the camera 50 described above.

Here, the partial image generation processing in Step S13 in FIG. 13 will be further described. In the example described above, the partial images are generated based on the divided areas obtained by dividing the captured image into four. However, the number of divided areas of the captured image is not limited to four, and the captured image may be divided into, for example, nine or 16.

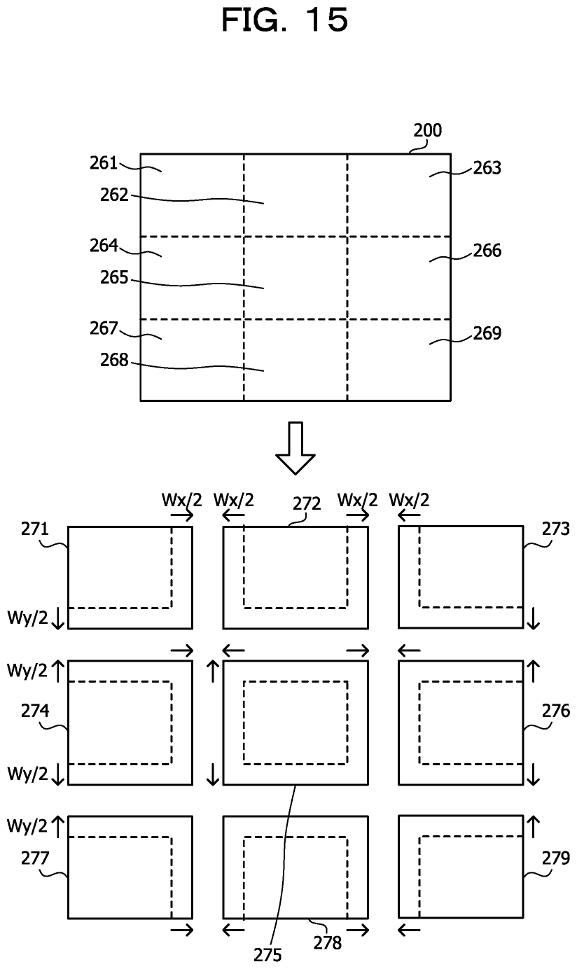

FIG. 15 is a diagram illustrating an example of generation of partial images based on divided areas divided into nine. In the example in FIG. 15, nine partial images 271 to 279 are respectively generated based on divided areas 261 to 269 obtained by dividing the captured image 200 into nine.

For example, the partial image 271 is generated by cutting out an area obtained by enlarging the divided area 261 in the right direction by Wx/2 and in the downward direction by Wy/2 from the captured image 200. The partial image 272 is generated by cutting out an area obtained by enlarging the divided area 262 in each of the left direction and the right direction by Wx/2 and in the downward direction by Wy/2 from the captured image 200. The partial image 273 is generated by cutting out an area obtained by enlarging the divided area 263 in the left direction by Wx/2 and in the downward direction by Wy/2 from the captured image 200.

Furthermore, the partial image 274 is generated by cutting out an area obtained by enlarging the divided area 264 in the right direction by Wx/2 and in each of the upward direction and the downward direction by Wy/2 from the captured image 200. The partial image 275 is generated by cutting out an area obtained by enlarging the divided area 265 in each of the left direction and the right direction by Wx/2 and in each of the upward direction and the downward direction by Wy/2 from the captured image 200. The partial image 276 is generated by cutting out an area obtained by enlarging the divided area 266 in the left direction by Wx/2 and in each of the upward direction and the downward direction by Wy/2 from the captured image 200.

Furthermore, the partial image 277 is generated by cutting out an area obtained by enlarging the divided area 267 in the right direction by Wx/2 and in the upward direction by Wy/2 from the captured image 200. The partial image 278 is generated by cutting out an area obtained by enlarging the divided area 268 in each of the left direction and the right direction by Wx/2 and in the upward direction by Wy/2 from the captured image 200. The partial image 279 is generated by cutting out an area obtained by enlarging the divided area 269 in the left direction by Wx/2 and in the upward direction by Wy/2 from the captured image 200.

From the example in FIG. 15, in Step S13 in FIG. 13, areas in a horizontal direction and a vertical direction of the partial images based on the corresponding divided areas are determined as follows. Note that, in FIG. 15, “partial images in a left end portion” correspond to the partial images 271, 274, and 277, “partial images in an intermediate portion relative to the horizontal direction” correspond to the partial images 272, 275, and 278, and “partial images in a right end portion” correspond to the partial images 273, 276, and 279. Furthermore, “partial images in an upper end portion” correspond to the partial images 271 to 273, “partial images in an intermediate portion relative to the vertical direction” correspond to the partial images 274 to 276, and “partial images in a lower end portion” correspond to the partial images 277 to 279.

### <Areas in Horizontal Direction of Partial Images>

The partial images in the left end portion: areas obtained by enlarging the corresponding divided areas by Wx/2 in the right direction.

The partial images in the intermediate portion relative to the horizontal direction: areas obtained by enlarging the corresponding divided areas by Wx/2 in each of the left direction and the right direction.

The partial images in the right end portion: areas obtained by enlarging the corresponding divided areas by Wx/2 in the left direction.

### <Areas in Vertical Direction of Partial Images>

The partial images in the upper end portion: areas obtained by enlarging the corresponding divided areas by Wy/2 in the downward direction.

The partial images in the intermediate portion relative to the vertical direction: areas obtained by enlarging the corresponding divided areas by Wy/2 in each of the upward direction and the downward direction.

The partial images in the lower end portion: areas obtained by enlarging the corresponding divided areas by Wy/2 in the upward direction.

Note that, the processing functions of the device (for example, the image processing device 1 or the vehicle detection device 100) described in each embodiment described above may be implemented by a computer. In that case, a program describing processing content of functions to be held by each device is provided, and the processing functions described above are implemented in the computer by execution of the program in the computer. The program describing the processing content may be recorded in a computer-readable recording medium. Examples of the computer-readable recording medium include a magnetic storage device, an optical disk, a semiconductor memory, or the like. Examples of the magnetic storage device include a hard disk drive (HDD), a magnetic tape, or the like. Examples of the optical disk include a compact disc (CD), a digital versatile disc (DVD), a Blu-ray disc (BD, registered trademark), or the like.

In a case where the program is to be distributed, for example, portable recording media such as DVDs or CDs in which the program is recorded are sold. Furthermore, it is also possible to store the program in a storage device of a server computer, and transfer the program from the server computer to another computer via a network.

The computer that executes the program stores, for example, the program recorded in the portable recording medium or the program transferred from the server computer in its own storage device. Then, the computer reads the program from its own storage device, and executes processing according to the program. Note that the computer may also read the program directly from the portable recording medium and execute the processing according to the program. Furthermore, the computer may also sequentially execute processing according to the received program each time the program is transferred from the server computer coupled via the network.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a process, the process comprising:
determining a size of an overlapping area such that adjacent divided areas among a plurality of divided areas obtained by dividing a captured image have the overlapping area with each other across a boundary between the adjacent divided areas;
determining a plurality of partial areas that respectively correspond to the plurality of divided areas based on the determined size of the overlapping area; and
cutting out a plurality of partial images that respectively correspond to the plurality of partial areas from the captured image.

2. The non-transitory computer-readable recording medium according to claim 1, wherein
one or more instances of a predetermined object appear in the captured image, and
the process further comprises:
detecting any instance of the predetermined object from each of the plurality of partial images.

3. The non-transitory computer-readable recording medium according to claim 2, the process further comprising:
referring to a storage unit that stores sizes of detection areas in which any instances of the predetermined object are detected from one or more input images; and
determining the size of the overlapping area based on the sizes of the detection areas.

4. The non-transitory computer-readable recording medium according to claim 3, the process further comprising:
determining the size of the overlapping area based on an average value of the sizes of the detection areas stored in the storage unit.

5. The non-transitory computer-readable recording medium according to claim 3, the process further comprising:
determining a first width of the overlapping area between adjacent partial areas among the plurality of partial areas based on an average value and a standard deviation of second widths in a direction of the first widths in the sizes of detection areas stored in the storage unit.

6. The non-transitory computer-readable recording medium according to claim 2, the process further comprising:
in a case where a first instance of the predetermined object is detected from a first partial image among the plurality of partial images, enlarging a first detection area where the first instance is detected in the first partial image by a ratio of a size of a first divided area that corresponds to the first partial image among the plurality of divided areas to a size of the first partial image; and
storing a size of the enlarged first detection area in the storage unit.

7. An image processing method, comprising:
determining, by a computer, a size of an overlapping area such that adjacent divided areas among a plurality of divided areas obtained by dividing a captured image have the overlapping area with each other across a boundary between the adjacent divided areas;
determining a plurality of partial areas that respectively correspond to the plurality of divided areas based on the determined size of the overlapping area; and
cutting out a plurality of partial images that respectively correspond to the plurality of partial areas from the captured image.

8. An information processing device, comprising:
a memory; and
a processor coupled to the memory and the processor configured to:
determine a size of an overlapping area such that adjacent divided areas among a plurality of divided areas obtained by dividing a captured image have the overlapping area with each other across a boundary between the adjacent divided areas;
determine a plurality of partial areas that respectively correspond to the plurality of divided areas based on the determined size of the overlapping area; and
cut out a plurality of partial images that respectively correspond to the plurality of partial areas from the captured image.
